(19) United States
(12) Patent Application Publication
(10) Pub. No.: US 2011/0034092 A1
(43) Pub. Date: Feb. 10, 2011

(54) PAD AND METHOD OF ASSEMBLY THE SAME TO CONNECTOR

(75) Inventor: YU ZHU, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/850,053

(22) Filed: Aug. 4, 2010

(30) Foreign Application Priority Data
Aug. 4, 2009 (CN) 200910305141.3

(51) Int. Cl. H01R 13/02; H01R 43/04

(52) U.S. Cl. 439/884; 29/882

(57) ABSTRACT

A pad includes a retaining portion and a soldering portion. The retaining portion has a through hole running therethrough in a thickness direction of the metal sheet and four side edges perpendicular to the metal sheet. The soldering portion extends from a first side edge of the retaining portion. The whole of the pad is electroplated except two opposite third and forth side edges of the retaining portion which connect with opposite ends of the first side edge.

### BACKGROUND OF THE INVENTION

1. Field of the Invention

The present invention relates to a pad and an assembly method of the pad into an insulating housing of an electrical connector to retain the electrical connector to a printed circuit board.

2. Description of the Related Art

Referring to FIG. 3 illustrating a traditional assembly method of a pad to an electrical connector, the assembly steps include: firstly, preparing a unity metallic strip and then stamping a pad strip 1′ out of the unity metallic strip, the pad strip 1′ including a scrapping portion 11′ having a plurality of translating holes 111′ and a plurality of pads 12′ connecting with the scrapping portion 11′, each pad 12′ defining a connecting face 121′ connecting with the scrapping portion 11′, the scrapping portion 11′ defining a plurality of connecting portions 112′ connecting with the connecting faces 121′, each connecting face 121′ forming a pair of slight cutouts 122′ at two sides of the connecting portion 112′ so that the pads 12′ are easy to be broken away from the scrapping portion 11′; secondly, electroplating the pad strip 1′ to prevent the pads 12′ from oxygenated, the step not be shown on the FIG. 3; thirdly, cutting the pad strip 1′ into a plurality of independent pad strips 2′ and each independent pad strip 2′ just including a pad 12′ and a part of the scrapping portion 11′; lastly, inserting the independent pad strip 2′ into a receiving groove 31′ of an insulative housing 3′, and then cutting the scrapping portion 11′ away from the pad 12′, the connecting face 121′ of the pad 12′ forming a broken face 1211′ which is not electroplated.

In view of the above, a new pad that overcomes the above-mentioned disadvantages is desired.

### SUMMARY OF THE INVENTION

Accordingly, an object of the present invention is to provide a pad which not only can be easily assembled into an insulating housing of an electrical connector to retain the electrical connector to a printed circuit board but also is low cost.

To fulfill the above-mentioned object, a pad comprises a retaining portion and a soldering portion. The retaining portion has a through hole running therethrough in a thickness direction of the metal sheet and four side edges perpendicular to the metal sheet. The soldering portion extends from a first side edge of the retaining portion. The whole of the pad is electroplated except two opposite third and forth side edges of the retaining portion which connect with opposite ends of the first side edge.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a pad of the present invention;

FIG. 2 is an illustrating view of an assembly method of the pad into an electrical connector; and

FIG. 3 is an illustrating view of a traditional assembly method of a pad into an electrical connector.

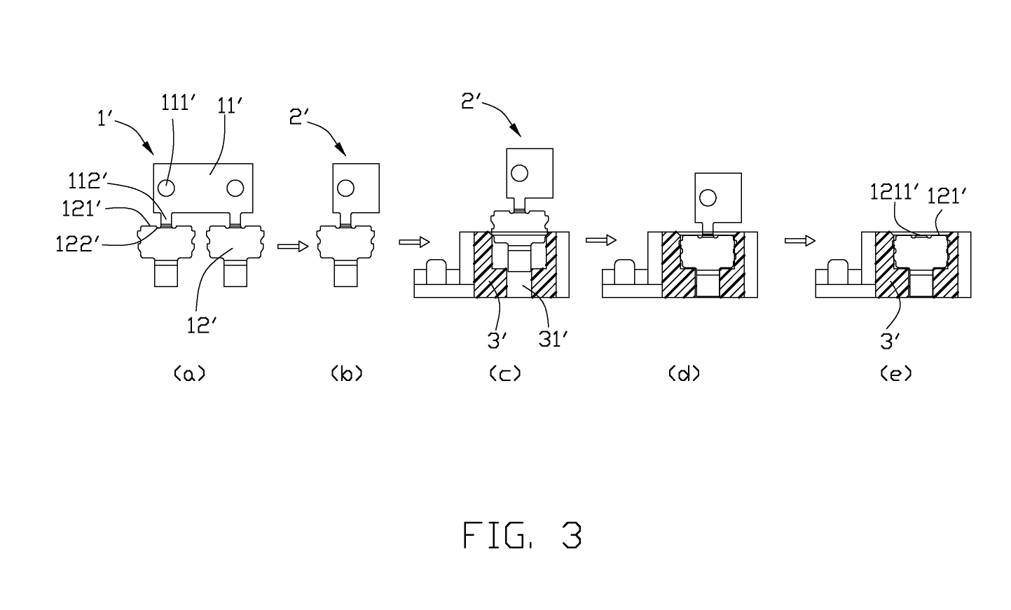

### DETAILED DESCRIPTION OF THE PREFERRED EMBODIMENT OF THE INVENTION

Reference will now be made to the drawings to describe the present invention in detail.

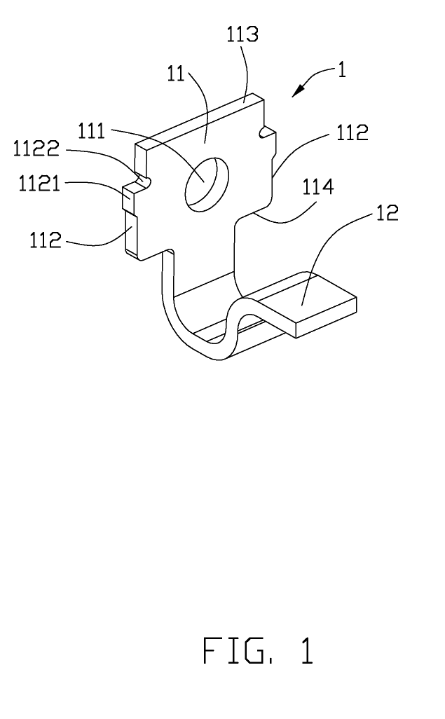

Referring to FIG. 1, a pad 1 made from a metal sheet includes a retaining portion 11 having a through hole 111 running therethrough in a thickness direction of the metal sheet and a soldering portion 12 welding to a PCB (not shown). The retaining portion 11 defines four side edges perpendicular to the metal sheet. The four side edges includes a pair of opposite first and second side edges 114, 113 and a pair of opposite third and fourth side edges 112 respectively connecting two ends of the first and second side edges 114, 113. The soldering portion 12 extends away from the first side edge 114 and then bends reversely. The soldering portion 12 extends perpendicular to the retaining portion 11. The second side edge 113 is of a straight line. The third and forth side edges 112 respectively have a barb 1121 projecting therefrom to and a recess 1122 is defined at a root of the barb 1121. The whole of the pad 1 is electroplated except two opposite third and forth side edges 112 of the retaining portion 11.

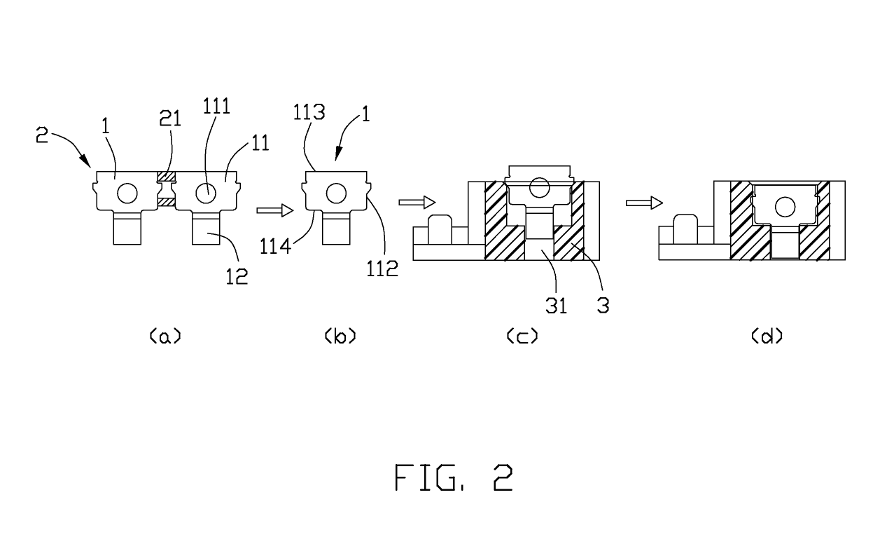

Referring to FIG. 2 showing an assembly method of making the pad 1. Firstly, preparing a unity metallic strip (not shown) and then stamping a plurality of pads 1 on the strip along an extending direction of the unity metallic strip to forming a stamping strip 2. The pads 1 integrally connect with each other by connecting portions 21 in the extending direction, wherein each pad 1 includes the retaining portion 11 and the soldering portion 12 extending from the retaining portion 11, the through holes 111 been as a translating holes and the stamping strip 2 is transported by the through holes 111. Secondly, electroplating the stamping strip 2 to prevent the pads 1 from oxygenated, the step not be shown on the FIG. 2, the whole stamping trip 2 is electroplated and please notes that the first and second side edges 113, 114 are covered with plated layer. Thirdly, cutting said one pad 1 from the stamping strip 2 and automobile transporting the pads 1 to a pre-determinated position which detects by the through holes 111 and then inserting the pads 1 to a receiving room 31 of an insulative housing 3. Please notes, the third and fourth side edges 112 at which the connecting portions 21 are disposed expose the metallic sheer material out without any plated layer since the cutting process is after the electroplating process. The material cost of the metallic sheet is lower since the larger scrapping portion of the conventional art is replaced with a smaller connecting portion 21.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pad made from a metal sheet, comprising:
a retaining portion having a through hole running therethrough in a thickness direction of the metal sheet, the retaining portion having opposite first and second edges and opposite third and fourth edges commonly perpendicular to the metal sheet;
a soldering portion extending from a first side edge of the retaining portion; wherein
the whole of the pad is electroplated except two opposite third and forth side edges of the retaining portion which connect with opposite ends of the first side edge.

2. The pad as claimed in claim 1, wherein a second side edge of the retaining portion is opposite to the first side edge and connects with one ends of the third and forth side edges, the second side edge is of a straight line.

3. The pad as claimed in claim 2, wherein the third and forth side edges respectively has a barb projecting therefrom to and a recess is defined at a root of the barb.

4. The pad as claimed in claim 3, wherein the soldering portion extends away from the first side edge and then bends reversely.

5. The pad as claimed in claim 1, wherein the soldering portion extends perpendicular to the retaining portion.

6. The pad as claimed in claim 1, wherein said first edge and said second edge are parallel to each other, and said third edge and said fourth edge are parallel to each other.

7. An assembly method of pads to electrical connectors, comprising:
preparing a unity metallic strip;
stamping a plurality of pads on the strip along an extending direction of the strip, the pads integrally connecting with each other by connecting portions in the extending direction, each pad including a retaining portion with a through hole thereof and a soldering portion extending from the retaining portion;
electroplating the stamping strip;
the pads being transported to a pre-determinated position which detects by the through holes and then being inserted to the electrical connectors.

8. The assembly method of pads to electrical connectors as claimed in claim 7, wherein cutting off the connection portions to get one single pad which is inserted in to one receiving room of one electrical connector, the pad has a pair of opposite side edges exposing without any plated layer.

9. The assembly method of pads to electrical connectors as claimed in claim 8, wherein the pair of side edges has barbs interfering with the receiving room.

10. The assembly method of pads to electrical connectors as claimed in claim 9, wherein the retaining portion defines a first side edge from which the soldering portion extends and a second side edge opposite to the first side edge and covered with plated layer wholly.

11. An mounting pad stamped from a metallic sheet for use with an electrical connector, comprising:
a planar retaining portion defining a through hole along a thickness direction and two opposite side edges; and
a pair of barb structure formed on the two opposite side edges under condition that an upper region and a lower region of each of said side edges are respectively located by two sides of the corresponding barb structure and originally, in temporary situation of a manufacturing process, connected to a linking carrier structure which links the mounting pad and a neighboring mounting pad before the mounting pad is separated from a neighboring mounting pad; wherein
a layer is plated upon the whole mounting pad except said upper region and the lower region of each of the side edges due to such plating occurring before the mounting pad is severed from the linking carrier structure.

12. The mounting pad as claimed in claim 11, wherein a soldering section unitarily extends from a bottom edge of the retaining portion.

13. The mounting pad as claimed in claim 12, wherein said soldering section is of a Z-shaped configuration.
